(19) United States
(12) Patent Application Publication
(10) Pub. No.: US 2026/0309164 A1
(43) Pub. Date: Oct. 8, 2026

(54) FAN MOTOR

(71) Applicant: LG ELECTRONICS INC., Seoul (KR)

(72) Inventors: Taekyung KIM, Seoul (KR); Sunho KIM, Seoul (KR); Jounyoung KIM, Seoul (KR); Seongho CHO, Seoul (KR)

(21) Appl. No.: 19/462,671

(22) Filed: Jan. 28, 2026

(30) Foreign Application Priority Data
Feb. 3, 2025 (KR) 10-2025-0013132

(51) Int. Cl. F04D 29/44; F04D 17/08; F04D 25/06; F04D 29/58

(52) U.S. Cl. CPC F04D 29/444; F04D 17/08; F04D 25/0606; F04D 29/5806; F04D 29/5813

(57) ABSTRACT

The present invention relates to a fan motor including a housing, an impeller, a motor, and a guide vane which is disposed on the one side of the impeller and allows air discharged from the impeller to flow therein, wherein the guide vane includes an inner member disposed to surround the motor and having a motor accommodation space therein, an outer member disposed to be spaced apart from the inner member with a space interposed therebetween and coupled to the housing, and a plurality of vanes disposed between the inner member and the outer member, the inner member has at least one slit which allows the motor accommodation space to communicate with spaces in which the vanes are disposed, thereby providing a heat dissipation structure.

### CROSS REFERENCE TO RELATED APPLICATION

The present application claims priority to Korean Patent Application No. 10-2025-0013132, filed Feb. 03, 2025, the entire contents of which is incorporated herein for all purposes by this reference.

### BACKGROUND OF THE INVENTION

### Field of the Invention

The present invention relates to a fan motor, and more specifically, to a fan motor providing a heat dissipation function.

### Description of the Related Art

A fan motor generates a suction force by rotating a fan (impeller) connected to a rotational shaft of the motor. The fan motor is used in various devices. The fan motor is used in home appliances, such as cleaners, air conditioners, and the like, vehicles, etc. For example, when the fan motor is used in the cleaner, air suctioned by the fan motor flows to a filter of the cleaner.

The fan motor typically includes a motor and an impeller connected to a rotational shaft of the motor. A guide vane may be provided between the motor and the impeller.

When the motor rotates, the impeller connected to the rotational shaft of the motor also rotates. Air is suctioned toward the impeller by rotating the impeller. A flow of air discharged from the impeller is guided by the guide vanes and discharged toward the motor.

A portion of the air discharged from the impeller enters the motor. The air entering the motor cools the motor and is discharged outward from the motor.

Meanwhile, in the field of home appliances such as a cleaner and the like, miniaturization and weight reduction are being pursued for user convenience. In this case, a smaller maximum outer diameter of the fan motor is more effective in achieving miniaturization and weight reduction.

In this regard, Chinese Patent Registration No. CN 113530868B discloses a fan motor including vanes and holes to guide a portion of a main flow discharged from an impeller toward a motor. In this case, losses occur as a portion of the main flow discharged from the impeller is used to cool the motor, in particular, losses also occur during the process of arbitrarily allowing a portion of the main flow to flow toward the motor.

In addition, the fan motor has a limitation of low cooling efficiency because air heated while flowing through the impeller cools the hotter motor.

Meanwhile, Chinese Utility Model Registration No. CN 208950918U discloses a blower device, which includes holes formed in a circuit board to discharge a portion of a main flow discharged from a flow path of the blower through the holes of the circuit board.

However, there is a limitation in that a portion of the main flow of the blower device diverges from the main flow to pass through the holes in the circuit board, resulting in losses, and an internal space in which the motor is disposed suffers from a stagnant flow, leading to a rapid temperature rise.

### SUMMARY OF THE INVENTION

The present invention has been devised to solve the above problems of conventional fan motors and is directed to providing a fan motor that eliminates flow stagnation within a space in which a motor is disposed.

Specifically, the present invention is directed to providing a fan motor that guides air circulation by eliminating the flow stagnation that occurs between a guide vane and a motor in a structure in which the motor is disposed within the guide vane to reduce an axial length.

In addition, the present invention is directed to providing a fan motor that has a heat dissipation structure that allows the motor accommodation space to communicate with a space in which a vane is installed in a guide vane to merge air of a motor accommodation space into a main flow discharged from an impeller to a vane of a guide vane.

In addition, the present invention is directed to providing a fan motor that includes an outside air inlet on a circuit board to supply outside air to a motor accommodation space to effectively cool a motor.

According to the present invention, there is provided a fan motor including a housing, an impeller mounted on a rotational shaft and disposed inside the housing, a motor which is disposed on one side of the impeller and drives the rotational shaft, and a guide vane which is disposed on the one side of the impeller and allows air discharged from the impeller to flow therein, wherein the guide vane includes an inner member disposed to surround the motor and having a motor accommodation space therein, an outer member disposed to be spaced apart from the inner member with a hollow space interposed therebetween and coupled to the housing, and a plurality of vanes disposed between the inner member and the outer member, and the inner member includes at least one slit which allows the motor accommodation space to communicate with spaces in which the vanes are disposed.

The inner member may be formed such that the slit is disposed between the plurality of vanes.

The inner member may be formed such that the slit is formed parallel to an axial direction on an end portion of the inner member and has one open side.

The inner member may be formed such that the slit is disposed to be spaced apart from the vane.

The motor may include a rotor fixed to the rotational shaft, and a stator disposed to surround the rotor, and the inner member may be formed such that the slit is disposed to overlap at least a portion of the stator in the axial direction.

The inner member may be formed such that the slit has an axial length of 12 mm or more and 14 mm or less.

The guide vane may further include an upper wall coupled to the impeller, the motor may be spaced apart from the upper wall and disposed in the motor accommodation space, and the inner member may be formed such that an upper end portion of the slit is disposed on the same plane as an upper end portion of the stator.

The slit may be cut from the end portion of the inner member to a point at which the inner member and the vane intersect each other.

The vane may be disposed to be inclined along at least one of a spiral shape and a curved shape between the inner member and the outer member, and the inner member may be formed such that the slit is disposed along the vane on the end portion of the inner member and has one open side.

The inner member may have one to six slits, and when the slits is formed as a plurality of slits, the slits may be provided to be spaced equal distances from each other in a circumferential direction.

The motor may include a rotor fixed to the rotational shaft, and a stator which is disposed to surround the rotor and has a plurality of teeth and on which a coil is installed, and the inner member may be formed such that the slit is disposed between the teeth.

The inner member may be formed such that a width of the slit has an arc length whose central angle is 1 degree or more and 5 degrees or less in a circumferential direction of the inner member. The guide vane may be provided in multiple stages in the axial direction. When a two-stage guide vane is provided, the guide vane may include a first inner member and a second inner member disposed on one side and the other side, respectively, in an axial direction and formed by dividing the inner member, a first outer member and a second outer member disposed on the one side and the other side, respectively, in the axial direction and formed by dividing the outer member, a plurality of first vanes disposed in a spiral shape between the first inner member and the first outer member, and a plurality of second vanes disposed in a spiral shape between the second inner member and the second outer member, and the slit may include a divided slit provided in the first inner member, disposed on an end portion of the first inner member in an axial direction, and having one open side, and a slit extension hole provided in the second inner member, connected to the divided slit, and formed such that both sides in the axial direction are open.

The second inner member may have a reinforcing rib connecting both side surfaces of the slit extension hole in a circumferential direction.

The fan motor may further include a circuit board disposed to be spaced apart from the motor in the axial direction, wherein the circuit board may have an outside air inlet for guiding outside air into a space between the motor and the circuit board.

The outside air inlet may be an outside air inflow hole provided at a center of the circuit board.

The outside air inlet may be a plurality of outside air inflow holes spaced apart from a center of the circuit board.

In addition, according to the present invention, there is provided a fan motor including a housing, an impeller mounted on a rotational shaft and disposed inside the housing, a motor which is disposed on one side of the impeller and drives the rotational shaft, and a guide vane which is disposed on the one side of the impeller and allows air discharged from the impeller to flow therein, wherein the guide vane includes an inner member disposed to surround the motor and having a motor accommodation space therein, an outer member disposed to be spaced apart from the inner member with a space interposed therebetween and coupled to the housing, and a plurality of vanes disposed between the inner member and the outer member, and the motor accommodation space includes an air pocket formed by stagnant airflow between the inner member and the motor, and the guide vane further includes a heat dissipation structure which is provided on the inner member and allows air in the air pocket to flow.

According to the flow of the air in the air pocket, outside air outside the motor may be supplied to the air pocket via the motor accommodation space from a lower end of the motor.

The heat dissipation structure may include at least one slit formed to pass through inner and outer surfaces of the inner member, and the stagnant air in the air pocket may merge with a main flow passing through the impeller and the guide vane through the slit.

As described above, in the fan motor according to the present invention, it is possible to effectively eliminate the flow stagnation flow within the space in which the motor is disposed and discharge stagnant air.

Specifically, it is possible to guide air circulation by eliminating the flow stagnation that occurs between the guide vane and the motor in the structure in which the motor is disposed within the guide vane to reduce the axial length, thereby achieving the heat dissipation effect.

In addition, by providing the heat dissipation structure that allows the motor accommodation space to communicate with the space in which the vane is disposed in the guide vane, it is possible to merge the air of the motor accommodation space into the main flow discharged from the impeller to the vane of the guide vane, thereby minimizing loss. In particular, since the slit is formed in the shape with a narrow width and a long axial length, the pressure of the main flow is not significantly affected when the air in the air pocket is merged, thereby minimizing loss.

In addition, by including the outside air inlet in the circuit board, the outside air can be supplied to the motor accommodation space, thereby effectively cooling the motor.

### BRIEF DESCRIPTION OF THE DRAWINGS

FIG. 1 is a perspective view for describing a fan motor according to one embodiment of the present invention.

FIG. 2 is an exploded perspective view of FIG. 1.

FIG. 3 is a cross-sectional view of FIG. 1.

FIG. 4 is a view illustrating a flow path of air in FIG. 3.

FIG. 5 is a bottom view of FIG. 1 with a circuit board removed.

FIG. 6 is a perspective view of a guide vane with an outer member of a fan motor according to a first embodiment of the present invention removed.

FIG. 7 is a perspective view of a guide vane with an outer member of a fan motor according to a second embodiment of the present invention removed.

FIG. 8 is a perspective view of a guide vane with an outer member of a fan motor according to a third embodiment of the present invention removed.

FIG. 9 is a perspective view of a guide vane with an outer member of a fan motor according to a fourth embodiment of the present invention removed.

FIG. 10 is a perspective view of a guide vane of a fan motor according to a fifth embodiment of the present invention.

FIG. 11 is a perspective view of a reinforcement rib provided on a second guide vane of the fan motor according to the fifth embodiment of the present invention.

FIG. 12 is a bottom view illustrating an outside air inlet provided on the circuit board of the fan motor according to the present invention.

FIG. 13 is a view illustrating an outside air inlet provided on a circuit board of a fan motor according to another embodiment of the present invention.

FIG. 14 is a view illustrating an outside air inlet provided on a circuit board of a fan motor according to still another embodiment of the present invention.

### DETAILED DESCRIPTION OF THE INVENTION

Hereinafter, exemplary embodiments of the present invention will be described in detail with reference to the accompanying drawings.

Since the present invention may have various changes and various embodiments, specific embodiments are illustrated in the accompanying drawings and specifically described in the detailed descriptions. This is not intended to limit the present invention to specific embodiments and should be construed to include all modifications, equivalents, and substitutes included in the spirit and technical scope of the present invention.

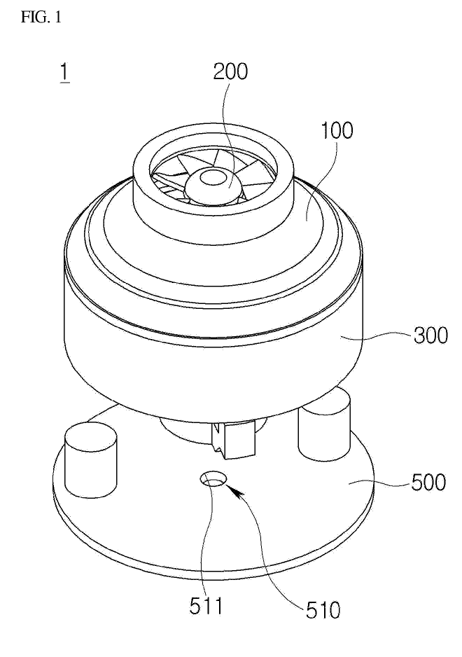

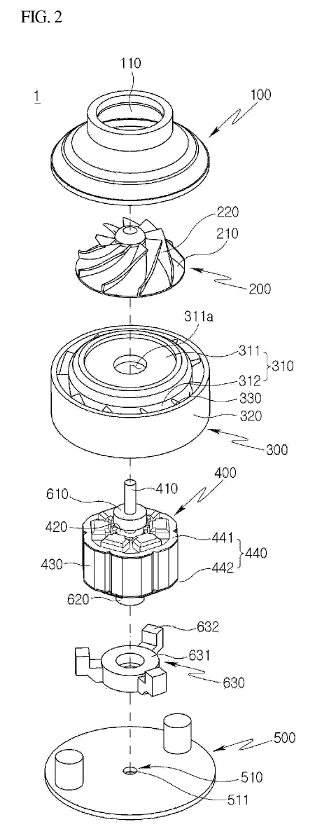

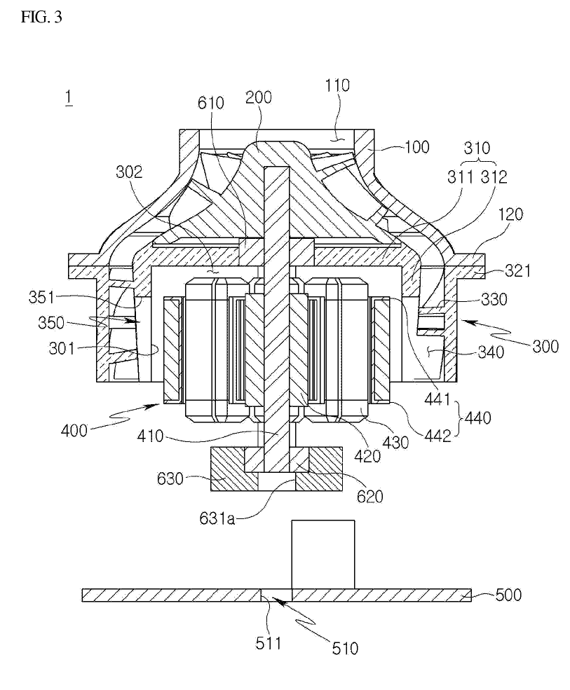

A fan motor 1 according to one embodiment of the present invention will be described with reference to FIGS. 1-5 as follows.

The fan motor 1 according to one embodiment of the present invention includes a housing 100, an impeller 200, a guide vane 300, a motor 400, and a circuit board 500.

The impeller 200 is disposed within the housing 100, and the guide vane 300 and the motor 400 are disposed at one axial side of the impeller 200. The motor 400 is inserted into and disposed in a motor accommodation space 301 provided in the guide vane 300, the circuit board 500 is disposed at one axial side thereof, and the impeller 200 is disposed at the other axial side.

For convenience, a direction in which the impeller 200 is disposed with respect to the motor 400 may be referred to as an upper side, and a direction in which the circuit board 500 is disposed may be referred to as a lower side. Specifically, a direction in which the impeller 200 is disposed in the motor 400 in a longitudinal direction of a rotational shaft 410 may be referred to as an upper side, and a direction in which the circuit board 500 is disposed may be referred to as a lower side.

The housing 100 may accommodate the impeller 200 therein. The housing 100 may be formed in a substantially hollow cylindrical shape. An opening of an upper portion of the housing 100 may serve as an air suction port 110 through which air is introduced.

The housing 100 may be formed in a bell-mouth shape with a diameter that increases from top to bottom. In addition, the housing 100 may be disposed to cover and surround the impeller 200 to guide the air introduced through the air suction port 110 to the guide vane 300.

In addition, the housing 100 may have a flange 321 whose lower end portion is formed to protrude radially outward, and the guide vane 300 may be fixedly mounted on the flange 321.

The impeller 200 is a centrifugal impeller that suctions air in the axial direction and blows the air in a centrifugal direction during rotation and may be formed as a mixed-flow impeller that suctions air in the axial direction and blows the air in an oblique direction between the axial and centrifugal directions.

The impeller 200 may include a hub 210 installed on the rotational shaft 410 and at least one blade 220 formed on an outer surface of the hub 210. An upper end of the housing 100 is open and has the air suction port 110, and air flows to the blades 220 through the air suction port 110. The impeller 200 may include the hub 210 that forms a space between the hub and the housing 100, and the blades 220 that are disposed in the space and generate a flow of the air introduced through the air suction port 110. The impeller 200 may generate a suction force to suction air while rotating about the center of the rotational shaft 410 during rotation of the rotational shaft 410 and suction air through the air suction port 110 of the housing 100.

The hub 210 may be connected to an end portion of the rotational shaft 410 positioned inside the housing 100. That is, the hub 210 may be coupled to an upper end of the rotational shaft 410.

A hollow into which the rotational shaft 410 is inserted may be formed in a central portion of the hub 210.

The hub 210 may be formed in a shape in which an outer diameter gradually expands in a direction approaching a rotor 420.

The hub 210 may be formed such that an outer diameter of one axial end portion close to the air suction port 110 formed on the housing 100 is the smallest and an outer diameter of the other axial end portion close to the rotor 420 is the largest. A maximum outer diameter of the hub 210 may be an outer diameter of an end portion close to the rotor 420 of both ends of the hub 210.

A plurality of blades 220 may be formed on the outer surface of the hub 210, and the plurality of blades 220 may be disposed to be spaced apart from each other in a circumferential direction of the impeller 200.

The blade 220 may be formed as a curved plate shape, and both surfaces thereof may include a pressure-side surface and a suction-side surface.

The blade 220 may be formed in a three-dimensional shape and may include a leading edge at the foremost end in the flow direction of the air and a trailing edge at the rearmost end in the flow direction of the air.

The blade 220 may have a blade tip positioned at the outermost side with respect to a center axis of the hub 210. The blade tip may be an outer tip positioned at the outermost side of the blade 220.

The blade 220 may have the leading edge and the trailing edge connected by the blade tip. The blade tip may connect a tip of the leading edge farthest from the hub 210 to a tip of the trailing edge farthest from the hub 210. In addition, the impeller 200 in which the plurality of blades 220 are disposed may be formed in a straight or curved shape with an outer diameter that increases from top to bottom, and an inner surface of the housing 100 may be formed to correspond to a generatrix of the impeller 200. That is, the plurality of blade tips are disposed in contact with the inner surface of the housing 100 at a predetermined distance.

With this configuration, the air introduced through the air suction port 110 of the housing 100 flows along a first flow path a1 between the housing 100 and the impeller 200 and is then discharged to the guide vane 300.

The motor 400 is spaced apart from an upper wall 311 to be described below and disposed in the motor accommodation space 301. The motor 400 may include the rotational shaft 410, the rotor 420, and a stator 430.

The rotational shaft 410 may be disposed from a support 630 to be described below to the inside of the housing 100. The rotational shaft 410 may be rotatably positioned within the support 630 and the housing 100.

The rotational shaft 410 may rotate together with the rotor 420 and may be supported by bearings 610 and 620. The rotational shaft 410 may be rotated by the rotor 420 while supported by the bearings 610 and 620.

The rotational shaft 410 is rotatably supported by the guide vane 300 via a first bearing 610 and rotatably supported by the support 630 via a second bearing 620.

Here, the support 630 may be a component fixed to a motor housing or fixed to a cleaner. The support 630 may include a rotational shaft support portion 631 which is formed in a hollow cylindrical shape and in which the second bearing 620 is installed, and a plurality of gripping portions 632 formed to radially protrude from the rotational shaft support portion 631 and support the motor 400. In addition, the rotational shaft support portion 631 is provided with a through hole 631a disposed to face an outside air inlet 510 to be described below.

The impeller 200 may be connected to the rotational shaft 410, and during the rotation of the rotational shaft 410, the impeller 200 may rotate within the housing 100. Accordingly, when the motor 400 is driven, the impeller 200 also rotates together with the rotor 420 to generate a suction force to suction air.

The rotor 420 may be rotatably positioned within the stator 430. The rotor 420 may be formed in a hollow cylindrical shape.

The rotor 420 may include a rotor core fixed to the rotational shaft 410 and a magnet installed on the rotor core.

The rotor 420 is mounted to surround a portion between one axial end and the other axial end of the rotational shaft 410 and rotate together with the rotational shaft 410.

The stator 430 may be mounted on the support 630 and mounted to the motor housing (not illustrated) through the support 630. The stator 430 may be disposed to surround the rotor 420, that is, is formed in a hollow shape, and the rotor 420 may be disposed within the stator 430.

The stator 430 has a plurality of teeth 431 provided to protrude radially toward the rotor 420, with a coil 432 wound around each tooth 431.

In addition, the stator 430 has end plates 440 disposed on both axial end portions thereof. The end plates 440 include a first plate 441 disposed on an upper end portion of the stator 430 and a second plate 442 disposed on a lower end portion of the stator 430.

The guide vane 300 is disposed at one side of the impeller 200 to guide the flow of the air discharged from the impeller 200. To reduce the overall axial length of the fan motor 1, the guide vane 300 may be disposed to overlap the motor 400 in the axial direction, and the guide vane 300 may be disposed to surround the motor 400. The motor 400 may be inserted into and disposed in the motor accommodation space 301 provided in the guide vane 300.

The guide vane 300 may include an inner member 310, an outer member 320, and at least one vane 330.

The inner member 310 may divide an internal space of the housing 100 and the motor accommodation space 301 and divide a space 340 in which the vane 330 to be described below is disposed and the motor accommodation space 301.

The inner member 310 may be disposed to surround the motor 400 and may have the motor accommodation space 301 therein. The inner member 310 is formed in a cylindrical shape and has the motor accommodation space 301 having one open side. For example, the inner member 310 may be formed in a cup shape, and the motor 400 may be inserted into and disposed within the inner member 310.

The inner member 310 includes a cylindrical body 312 disposed to surround an outer surface of the motor 400 and disposed to be spaced apart from the motor 400, and the upper wall 311 provided to cover one side of the cylindrical body 312 and disposed between the impeller 200 and the motor 400 in the axial direction.

The cylindrical body 312 may be formed in a hollow cylindrical shape. The cylindrical body 312 is provided so that an upper end portion is covered by the upper wall 311 and a lower end portion is open. The cylindrical body 312 may be formed such that the lower end portion is disposed adjacent to a second plate 442 disposed on the lower end portion of the stator 430 among the end plates 440 of the motor 400. In addition, at least half of the motor 400 is inserted into and disposed in the motor accommodation space 301, and an axial length of a portion inserted into the motor accommodation space 301 is disposed to be greater than an axial length of a portion not inserted into the motor accommodation space 301.

The upper wall 311 has a bearing insertion hole 311a through which the rotational shaft 410 passes, and the rotational shaft 410 is rotatably installed in the bearing insertion hole 311a through the first bearing 610.

The upper wall 311 may be disposed between the impeller 200 and the motor 400. The upper wall 311 has an impeller seating portion on an upper surface, and the impeller 200 may be rotatably coupled via the rotational shaft 410 and the first bearing 610. In this case, at least a portion of the upper wall 311 may be disposed inside the housing 100. In addition, an air pocket 302 to be described below is formed between a lower surface of the upper wall 311 and the motor 400. The air pocket 302 formed by stagnation of the introduced air may be formed between the upper wall 311 of the inner member 310 and the motor 400.

The outer member 320 and the inner member 310 are disposed with the hollow space 340 interposed therebetween and guide air. The outer member 320 may include the flange 321 coupled to the housing 100 at an upper end portion thereof, and the flange 321 whose upper end portion is formed to protrude radially outward may be provided. The flange 321 may be coupled to a coupling portion 120 of the housing 100 through a separate coupling member.

The cylindrical body 312 of the inner member 310 and the outer member 320 are formed in a hollow cylindrical shape, and the outer member 320 may be disposed radially outward of the cylindrical body 312.

The vane 330 may be disposed between the inner member 310 and the outer member 320 and provided as a plurality of vanes. The vane 330 may be disposed in a spiral or curved shape. Alternatively, the vane 330 may be disposed to have a hybrid shape of the spiral and curved shapes and disposed to be inclined. The vane 330 may connect an outer surface of the inner member 310 to an inner surface of the outer member 320. The vane 330 may guide the flow of air discharged from the impeller 200 in the axial direction. In this case, the vane 330 in the present invention include various known forms.

With this configuration, the air discharged from the impeller 200 flows along a second flow path a2 between the inner member 310 and the outer member 320 and is discharged to the outside. In addition, the second flow path a2 may be disposed on an outer surface of the motor 400 and disposed to surround the motor accommodation space 301.

The fan motor 1 according to the present invention provides an effective heat dissipation structure for the motor 400, and in particular, provides a heat dissipation structure that prevents air flow stagnation within the motor accommodation space 301. Specifically, there is provided a heat dissipation structure 350 that forms a flow in the air pocket 302 formed by the air flow stagnation between the upper wall 311 of the inner member 310 and the motor 400, thereby discharging hot air in the air pocket 302 to the outside.

The heat dissipation structure 350 may include slits 351, 352, 353, and 354 that is provided in the inner member 310 and allows the motor accommodation space 301 to communicate with the space 340 in which the vane 330 is disposed.

The slits 351, 352, 353, and 354 are formed to pass through the inner and outer surfaces of the inner member 310 and provided so that at least one side is open. As the slits 351, 352, 353, and 354 are provided, the air stagnant in the air pocket 302 may discharge the hot air in the air pocket 302 while flowing into the spaces 340 in which the vanes are disposed. In particular, it is possible to minimize loss by merging the hot air in the air pocket 302 into the main flow rather than being branched from the main flow of the air passing through the vane and flowing into the air pocket 302.

In this case, since the slits 351, 352, 353, and 354 are formed to have narrow widths and long axial lengths, when the air in the air pocket 302 merges into the main flow, the air does not significantly affect the pressure of the main flow.

Specifically, radially outside the cylindrical body 312 of the inner member 310, the air flows at a high flow speed along the vanes 330, creating a relatively low pressure area, and radially inside the cylindrical body 312, the air remains stagnant and absorbs heat from the motor 400, creating a high pressure area. Accordingly, as the slit 351 is provided in the inner member 310, air flows from the air pocket 302 to the space 340 in which the vanes in which pressure is low are disposed, and the air in the air pocket 302 is discharged.

In addition, due to the flow of hot air in the air pocket 302, relatively cool air outside the motor 400 may be circulated from a lower end of the motor 400 to the air pocket 302 through the motor accommodation space 301. Specifically, when outside air passes through the motor accommodation space 301, the outside air can effectively cool the motor 400 while passing through spaces between windings of the coils 432 of the motor 400 or a gap between the rotor 420 and the stator 430.

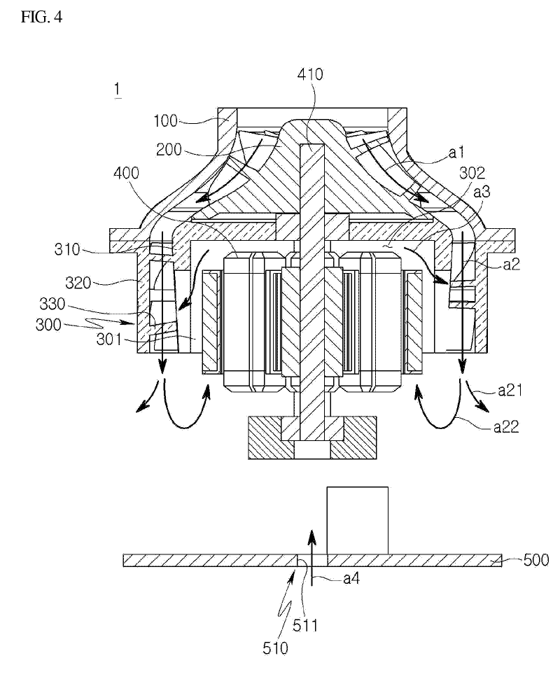

Referring to FIG. 4, the air introduced through the air suction port 110 flows along the first flow path a1 in the space in which the blades 220 between the housing 100 and the hub 210 are disposed during the rotation of the impeller 200 and is then discharged to the guide vane 300. In addition, the air flows along the second flow path a2 in the space 340 in which the vanes of the guide vane 300 are disposed, and then flows to the outside or to the filter of the cleaner. In this case, the main flow along the first flow path a1 and the second flow path a2 remains unbranched and may flow to the outside, thereby minimizing loss in the fan motor 1.

In addition, in the guide vane 300, the stagnant air in the air pocket 302 flows along a third flow path a3 to the spaces 340 in which the vanes are disposed and merges with the main flow of air introduced through the air suction port 110 and is discharged to the outside.

In this case, the air pocket 302 is disposed inside the motor accommodation space 301 and disposed between the upper wall 311 and the motor 400 and absorbs heat generated during the rotation of the rotational shaft 410 and heat generated from the motor 400, thereby decreasing temperature and discharges the stagnant air, thereby achieving the cooling effect. That is, the temperature of the third flow path a3 is higher than that of the second flow path a2, the air passing through the impeller 200 merges with hot air at the motor 400 side, and the merged air is discharged to the outside.

In addition, the second flow path a2 may be branched into a first branch flow path a21 through which air flows to the outside of the fan motor 1 when discharged to the outside, and a second branch flow path a22 through which the air recirculates into the motor accommodation space 301. However, in the present invention, circumferential widths of the slits 351, 352, 353, and 354 are narrowed to reduce the amount of air flowing to the second branch flow path a22, thereby minimizing loss in the fan motor 1.

In addition, the second branch flow path a22 may allow air to flow into the motor accommodation space 301 together with a fourth flow path a4 to be described below. Outside air may flow into the motor accommodation space 301 along the fourth flow path a4, and by introducing cool outside into the motor accommodation space 301, the motor 400 can be effectively cooled.

Each of the slits 351, 352, 353, and 354 is formed to have at least one open side. For example, when the inner member 310 is provided with a hole-shaped vent hole, a characteristic whistling noise increases and stagnant air in the air pocket 302 cannot be effectively circulated, and thus, the slits 351, 352, 353, and 354, each of which has one open side, are formed in the inner member 310.

In addition, the slits 351 and 352 are formed to be disposed parallel to the axial direction at the end portion of the inner member 310 and formed to have one open side. Specifically, the slits 351 and 352 are formed to be open downward. In addition, only when each of the slits 351 and 352 provided in the inner member 310 is formed with a narrow circumferential width and a long axial length and disposed adjacent to the air pocket 302, the air in the air pocket 302 can be effectively circulated.

For example, the inner member 310 may be formed such that the width of the slit 351 has an arc length whose central angle is 1 degree or more and 5 degrees or less in the circumferential direction of the inner member 310.

In order not to significantly affect a change in a pressure of the second flow path a2 when the air in the air pocket 302 is discharged to the second flow path a2, the width of the slit 351 needs to be formed to a predetermined width. That is, when the width of the slit 351 is formed with an arc length greater than a central angle of 5 degrees in the circumferential direction of the inner member 310, pressure loss can occur in the flow path of the main flow due to an increase in the pressure of the second flow path a2. In addition, when the width of the slit 351 is formed with an arc length less than a central angle of 1 degree in the circumferential direction of the inner member 310, it can be difficult to effectively discharge the air in the air pocket 302. Accordingly, the width of the slit 351 is preferably formed with an arc length of a central angle of 1 degree or more and 5 degrees or less in the circumferential direction of the inner member 310.

In addition, the inner member 310 may be disposed such that the slit 351 axially overlaps at least a portion of the stator 430. The inner member 310 may be provided with the slit 351 cut to a preset length. For example, the slit 351 may have an axial length of 12 mm or more and 14 mm or less.

In addition, the slit 351 may be disposed such that a distance from an upper end portion thereof to an upper surface of the second plate 442 is 12 mm or more and 14 mm or less. Accordingly, the slit 351 may cut through the first plate 441, effectively discharging the air in the air pocket 302.

In addition, the upper end portion of the slit 351 of the inner member 310 may be disposed on the same plane as the upper end portion of the stator 430. Specifically, an end surface of the slit 351 of the inner member 310 may be disposed on the same plane as a lower surface of the first plate 441 disposed on the upper end portion of the stator 430 among the end plates 440. Accordingly, the air in the air pocket 302 can be effectively discharged to the outside while minimizing loss of the flow path of the main flow through the guide vane 300.

In addition, the inner member 310 may be provided with at least one slit 351, that is, one to six slits, and when the plurality of slits 351 are provided, the slits 351 are provided to be spaced equal distances from each other in the circumferential direction. Accordingly, the air in the air pocket 302 can be uniformly discharged.

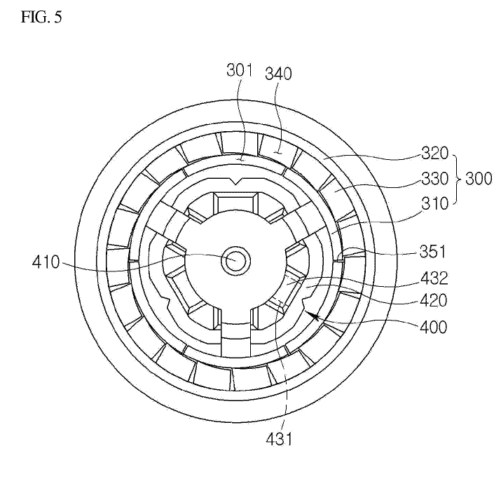

In particular, the inner member 310 may have the slits 351 disposed between the teeth 431. In the motor 400, as the coils 432 are wound around the teeth 431, a space may be formed between the coils 432 wound around the teeth 431, allowing air to flow more smoothly than in an area in which the coils 432 are disposed. Accordingly, the inner member 310 has the slits 351 disposed between the teeth 431, and for example, as illustrated in FIG. 5, six teeth 431 may be provided, and six slits 351 may also be provided and disposed at midpoints between the teeth 431.

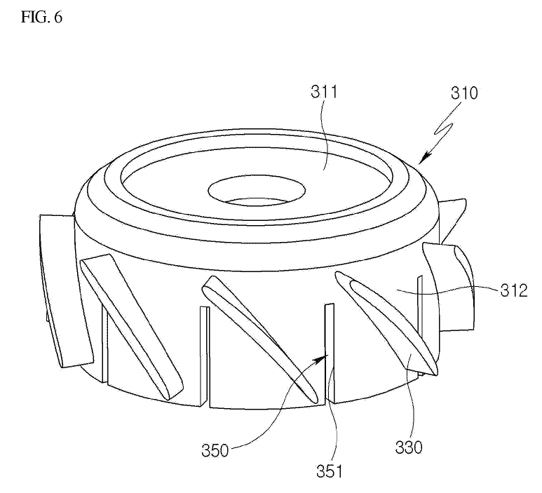

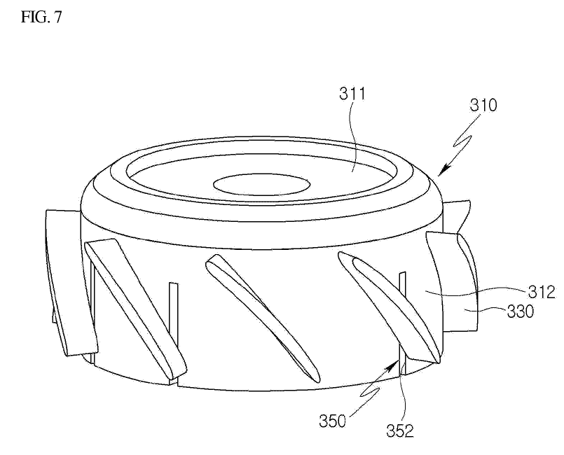

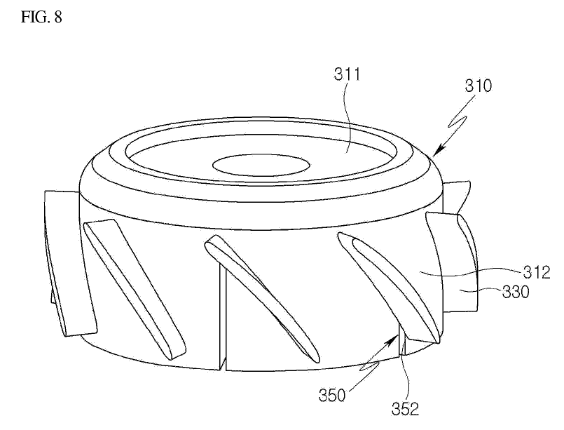

Meanwhile, the slits 351, 352, and 353 may be disposed to be spaced apart from the vane 330 as illustrated in FIG. 6 or disposed to overlap the vane 330 as illustrated in FIGS. 7 and 8.

The slit 351 may be disposed to be spaced apart from the vane 330 as illustrated in FIG. 6 and may not interfere with the vane 330, thereby facilitating injection molding. In addition, axial lengths of the slits 351 can be uniformly formed, thereby uniformly discharging the air of the air pocket 302.

Referring to FIG. 7, the heat dissipation structure 350 may include the slits 352 disposed to be spaced equal distances from each other in the circumferential direction regardless of the vane 330. At least some slits 352 may interfere with the vane 330 and may be formed in the inner member 310 to which the vane 330 is connected.

With this configuration, the slits 352 may be disposed to be spaced equal distances from each other in the circumferential direction on the inner member 310 regardless of the shape of the vane 330, and the air in the air pocket 302 can be uniformly discharged.

In addition, referring to FIG. 8, the heat dissipation structure 350 may include the slits 353 disposed to be spaced equal distances from each other in the circumferential direction regardless of the vane 330. However, the slit 353 may be cut from the end of the inner member 310 to the vane 330. That is, the slit 353 may be cut from the end of the inner member 310 to a point at which the inner member 310 and the vane 330 intersect each other.

With this configuration, the slits 353 may be disposed at equal distances in the circumferential direction of the inner member 310 regardless of the shape of the vane 330, thereby facilitating injection molding for the slits 353.

Meanwhile, referring to FIG. 9, the heat dissipation structure 350 may include the slits 354 disposed in a spiral shape along the vane 330. The inner member 310 may be formed such that the slits 354 are disposed along the vanes 330 at the end portion of the inner member 310, with one side open.

With this configuration, the slits 354 may be provided in a uniform shape to uniformly discharge the air in the air pocket 302, thereby facilitating injection molding for the slits 354.

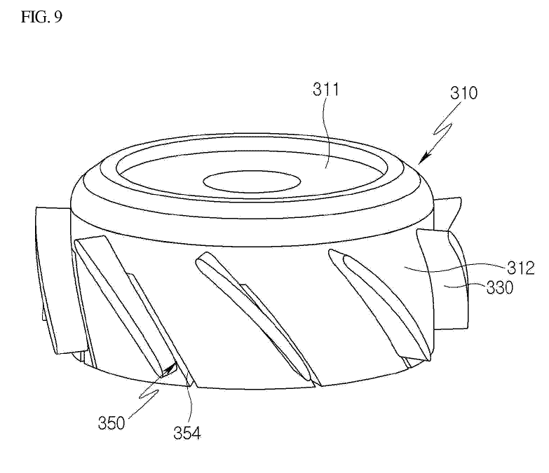

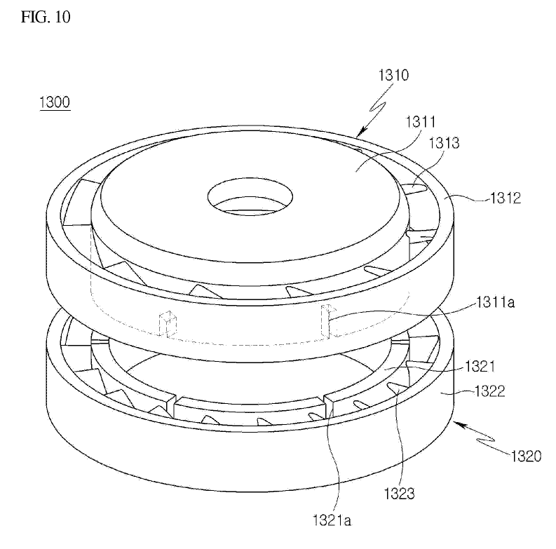

In addition, referring to FIG. 10, a guide vane 1300 may be formed by connecting a first guide vane 1310 to a second guide vane 1320. That is, the first guide vane 1310 may be disposed on one axial side, the second guide vane 1320 may be disposed on the other axial side, and the first guide vane 1310 and the second guide vane 1320 may be connected to form the guide vane 1300. The first guide vane 1310 may be disposed axially above the second guide vane 1320.

Specifically, the first guide vane 1310 may include a first inner member 1311, a first outer member 1312, and a first vane 1313.

The first inner member 1311 may be disposed to surround the upper portion of the motor 400 and may include the motor accommodation space 301 together with an internal space of the second inner member 1321. The first inner member 1311 is formed in a cup shape, with an impeller 200 mounted on an upper portion thereof, and the upper portion of the motor 400 is inserted into and disposed in the internal space formed to be open downward.

The first outer member 1312 and the first inner member 1311 are disposed with a hollow space interposed therebetween and guide air. The first outer member 1312 may be formed in a hollow shape, with the first inner member 1311 disposed radially inward.

The first vane 1313 is disposed in a spiral shape between the first inner member 1311 and the first outer member 1312 and is provided as a plurality of vanes.

The second guide vane 1320 may include a second inner member 1321, a second outer member 1322, and a second vane 1323.

The second inner member 1321 and the second outer member 1322 are formed in a hollow cylindrical shape, and the second inner member 1321 is disposed radially inward of the second outer member 1322.

The second vane 1323 is disposed in a spiral shape between the second inner member 1321 and the second outer member 1322 and is provided as a plurality of vanes.

In addition, the second guide vane 1320 is disposed to be connected to a lower side of the first guide vane 1310 and disposed such that a space between the first inner member 1311 and the first outer member 1312 is connected to a space between the second inner member 1321 and the second outer member 1322.

The guide vane 1300 formed in this way is provided with at least one slit. In this case, the slit is formed by connecting a divided slit 1311a of the first inner member 1311 to a slit extension hole 1321a of the second inner member 1321. The divided slit 1311a is disposed in the axial direction on an end portion of the first inner member 1311 and formed to be open downward.

In addition, the slit extension hole 1321a is provided at a position corresponding to the divided slit 1311a of the second inner member 1321 and is formed to be open both upward and downward in the axial direction.

In this case, the circumferential widths of the divided slit 1311a and the slit extension hole 1321a are preferably the same.

In addition, an upper end portion of the divided slit 1311a may be disposed on the same plane as the lower surface of the first plate 441. Alternatively, the upper end portion of the divided slit 1311a may be disposed such that an axial distance from a lower surface of the second plate 442 is 12 mm or more and 14 mm or less.

In addition, the second inner member 1321 may be divided into a plurality of arc-shaped panels by the slit extension holes 1321a and may include reinforcing ribs 1321b to connect the plurality of arc-shaped panels to secure the rigidity of the second inner member 1321.

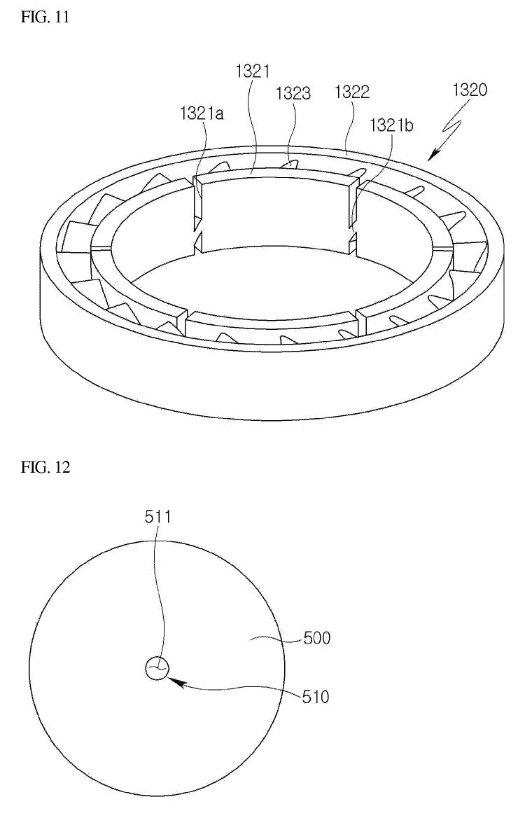

Referring to FIG. 11, the second inner member 1321 may include the reinforcing rib 1321b that connect both side surfaces of the slit extension hole 1321a in the circumferential direction. For example, the reinforcing ribs 1321b may be formed to be inclined upward from one side surface to the other side surface of the slit extension hole 1321a.

In addition, the fan motor 1 according to the present invention is provided with an outside air inlet 510 on the circuit board 500 to allow cool air to be introduced for cooling the motor 400.

The circuit board 500 is spaced apart from the rotational shaft in the axial direction and electrically connected to the motor 400. Various components may be disposed on a surface of the circuit board 500 facing the motor 400.

The circuit board 500 has the outside air inlet 510 for introducing outside air. The outside air introduced through the outside air inlet 510 flows toward the motor 400 along the fourth flow path a4. The outside air may flow into the air pocket 302 of the motor accommodation space 301 and flow into the through hole 631a of the support 630, thereby cooling the motor 400. The outside air inlet 510 may guide outside air into a space between the motor 400 and the circuit board 500, and the outside air may cool components provided on the circuit board 500 and the motor 400.

The outside air inlet 510 may be provided on the circuit board 500, disposed vertically below the rotational shaft 410, and disposed to face the through hole 631a of the support 630. The outside air inlet 510 may be disposed in a central portion of the circuit board 500, thereby effectively circulating air.

The outside air inlet 510 may be outside air inflow holes 511, 512, and 513 formed to pass through one surface and the other surface of the circuit board 500. In this case, a ratio of an area of each of the outside air inflow holes 511, 512, and 513 to an area of the circuit board 500 may be formed to be 3% or less.

Referring to FIG. 12, the outside air inlet 510 may be the outside air inflow hole 511 provided at the center of the circuit board 500. The outside air inflow hole 511 is formed to have a circular cross-section and has a smaller diameter than the through hole 631a.

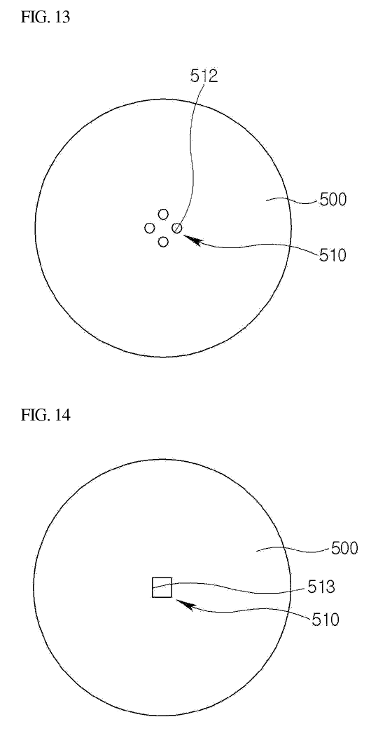

Referring to FIG. 13, the outside air inlet 510 may be a plurality of outside air inflow holes 512 disposed to be spaced apart from the center of the circuit board 500. The outside air inflow hole 512 may be provided as a plurality of holes and disposed adjacent to the center of the circuit board 500. In addition, the number and positions of outside air inflow holes 512 are not limited as long as the sum of their areas are a predetermined area or less. However, the plurality of outside air inflow holes 512 are preferably disposed within a 20% radius of the center of the circuit board 500.

In addition, referring to FIG. 14, the outside air inlet 510 may be the outside air inflow hole 513 formed to have a quadrangular cross section at the center of the circuit board 500.

However, the outside air inflow hole 513 is not limited to a quadrangular cross section and may be formed in a polygonal shape.

With this configuration, outside air is suctioned toward the motor 400 through the outside air inlet 510 of the circuit board 500 and merges into the second branch flow path a22 through which the cool air recirculates into the motor accommodation space 301, thereby effectively cooling the motor 400.

Although the present invention has been described in detail through specific embodiments, this is intended to specifically describe the present invention, and it is apparent that the present invention is not limited thereto, and the present invention can be modified or improved by those skilled in the art without departing from the technical spirit of the present invention.

All simple modifications or changes of the present invention fall within the scope of the present invention, and the specific scope of the present invention will be made clear by the appended claims.

### DESCRIPTION OF REFERENCE NUMERALS

1: fan motor

100: housing

200: impeller

300: guide vane

301: motor accommodation space

302: air pocket

310: inner member

320: outer member

330: vane

350: heat dissipation structure

351, 352, 353, 354: slit

400: motor

500: circuit board

What is claimed is:

1. A fan motor comprising:
a housing;
an impeller mounted on a rotational shaft and disposed inside the housing;
a motor which is disposed on one side of the impeller and drives the rotational shaft; and
a guide vane which is disposed on the one side of the impeller and allows air discharged from the impeller to flow therein,
wherein the guide vane includes:
an inner member disposed to surround the motor and having a motor accommodation space therein;
an outer member disposed to be spaced apart from the inner member with a hollow space interposed therebetween and coupled to the housing; and
a plurality of vanes disposed between the inner member and the outer member, and
the inner member includes at least one slit which allows the motor accommodation space to communicate with spaces in which the vanes are disposed.

2. The fan motor of claim 1, wherein the inner member is formed such that the slit is disposed between the plurality of vanes.

3. The fan motor of claim 1, wherein the inner member is formed such that the slit is formed parallel to an axial direction on an end portion of the inner member and has one open side.

4. The fan motor of claim 3, wherein the inner member is formed such that the slit is disposed to be spaced apart from the vane.

5. The fan motor of claim 3, wherein the motor includes:
a rotor fixed to the rotational shaft; and
a stator disposed to surround the rotor, and
the inner member is formed such that the slit is disposed to overlap at least a portion of the stator in the axial direction.

6. The fan motor of claim 3, wherein the inner member is formed such that the slit has an axial length of 12 mm or more and 14 mm or less.

7. The fan motor of claim 3, wherein the guide vane further includes an upper wall coupled to the impeller,
the motor is spaced apart from the upper wall and disposed in the motor accommodation space, and
the inner member is formed such that an upper end portion of the slit is disposed on the same plane as an upper end portion of the stator.

8. The fan motor of claim 3, wherein the slit is cut from the end portion of the inner member to a point at which the inner member and the vane intersect each other.

9. The fan motor of claim 1, wherein the vane is disposed to be inclined along at least one of a spiral shape and a curved shape between the inner member and the outer member, and
the inner member is formed such that the slit is disposed along the vane on the end portion of the inner member and has one open side.

10. The fan motor of claim 1, wherein the inner member has one to six slits, and when the slits is formed as a plurality of slits, the slits are provided to be spaced equal distances from each other in a circumferential direction.

11. The fan motor of claim 1, wherein the motor includes:
a rotor fixed to the rotational shaft; and
a stator which is disposed to surround the rotor and has a plurality of teeth and on which a coil is installed, and
the inner member is formed such that the slit is disposed between the teeth.

12. The fan motor of claim 1, wherein the inner member is formed such that a width of the slit has an arc length whose central angle is 1 degree or more and 5 degrees or less in a circumferential direction of the inner member.

13. The fan motor of claim 1, wherein the guide vane includes:
a first inner member and a second inner member disposed on one side and the other side, respectively, in an axial direction and formed by dividing the inner member;
a first outer member and a second outer member disposed on the one side and the other side, respectively, in the axial direction and formed by dividing the outer member;
a plurality of first vanes disposed in a spiral shape between the first inner member and the first outer member; and
a plurality of second vanes disposed in a spiral shape between the second inner member and the second outer member, and
the slit includes:
a divided slit provided in the first inner member, disposed on an end portion of the first inner member in an axial direction, and having one open side; and
a slit extension hole provided in the second inner member, connected to the divided slit, and formed such that both sides in the axial direction are open.

14. The fan motor of claim 13, wherein the second inner member has a reinforcing rib connecting both side surfaces of the slit extension hole in a circumferential direction.

15. The fan motor of claim 1, further comprising a circuit board disposed to be spaced apart from the motor in the axial direction,
wherein the circuit board has an outside air inlet for guiding outside air into a space between the motor and the circuit board.

16. The fan motor of claim 15, wherein the outside air inlet is an outside air inflow hole provided at a center of the circuit board.

17. The fan motor of claim 15, wherein the outside air inlet is a plurality of outside air inflow holes spaced apart from a center of the circuit board.

18. A fan motor comprising:
a housing;
an impeller mounted on a rotational shaft and disposed inside the housing;
a motor which is disposed on one side of the impeller and drives the rotational shaft; and
a guide vane which is disposed on the one side of the impeller and allows air discharged from the impeller to flow therein,
wherein the guide vane includes:
an inner member disposed to surround the motor and having a motor accommodation space therein;
an outer member disposed to be spaced apart from the inner member with a space interposed therebetween and coupled to the housing; and
a plurality of vanes disposed between the inner member and the outer member, and
the motor accommodation space includes an air pocket formed by stagnant airflow between the inner member and the motor, and
the guide vane further includes a heat dissipation structure which is provided on the inner member and allows air in the air pocket to flow.

19. The fan motor of claim 18, wherein the heat dissipation structure includes at least one slit formed to pass through inner and outer surfaces of the inner member, and
the stagnant air in the air pocket merges with a main flow passing through the impeller and the guide vane through the slit.
